(19) United States
(12) Patent Application Publication
(10) Pub. No.: US 2012/0028182 A1
(43) Pub. Date: Feb. 2, 2012

(54) TONER HAVING CORE-SHELL STRUCTURE AND METHOD OF PREPARING THE SAME

(75) Inventors: Ji Sang Jeong, Daejeon-city (KR); Il Hyuk Kim, Daejeon-city (KR); Dong Won Kim, Daejeon-city (KR); Ha Na Jung, Seoul (KR); Kyung Gyol Yon, Gyeonggi-do (KR)

(73) Assignee: SAMSUNG FINE CHEMICALS CO., LTD., ULSAN-CITY (KR)

(21) Appl. No.: 13/148,048

(22) PCT Filed: Jan. 26, 2010
(86) PCT No.: PCT/KR10/00459

§ 371 Date: Oct. 18, 2011

(30) Foreign Application Priority Data
Feb. 4, 2009 (KR) 10-2009-0008857

(51) Int. Cl. G03G 9/093

(52) U.S. Cl. 430/109.1; 430/137.13

(57) ABSTRACT

A toner having a core-shell structure and a method of preparing the same. Since a shell includes a crosslinked resin, a toner preventing hot offsets and having excellent charge stability is prepared.

### CROSS REFERENCE TO RELATED APPLICATIONS OR PRIORITY CLAIM

This application is a national phase of International Application No. PCT/KR2010/000459, entitled “TONER HAVING CORE-SHELL STRUCTURE, AND METHOD FOR PREPARING SAME”, which was filed on Jan. 26, 2010, and which claims priority of Korean Patent Application No. 10-2009-0008857, filed Feb. 4, 2009, the contents of which are incorporated herein by reference.

### DESCRIPTION

1. Technical Field

The present invention relates to a toner and a method of preparing the same, and more particularly, to a toner having a core-shell structure that prevents hot offsets and has excellent charge stability and a method of preparing the same.

2. Background Art

In electrophotographic imaging apparatuses, toner is generally fixed by heat roll fixation with high thermal efficiency and at high speed. However, according to this heat roll fixation, hot offset, which is a phenomenon in which some of toner adheres to the surface of a heating roll during a fixing process and is re-transferred to paper resulting in contamination of a subsequent image, may occur. A wrapping phenomenon in which paper is wrapped around a heating roll to stop the transfer of the paper may also occur. These phenomena may occur when viscoelasticity of toner that is melted by a heating roll is not suitable for printing or viscosity and elasticity of toner are not balanced. The viscoelasticity of toner may vary according to types of a binder resin, which is a main component of the toner, and types and contents of other components of the toner.

There is a temperature range suitable for fixing toner. However, since environmental temperature changes and a temperature of the surface of a heating roller significantly changes over a plurality of consecutive printings when an image is formed, it is preferable for toner to have a wide fixing temperature range.

In order to prevent hot offset and wrapping phenomena and improve fixing properties at high temperature, toner may include a releasing agent such as a low molecular weight wax. However, since toner particles may be melt-adhered to each other or toner may be melt-adhered to a charging member used in a developer when using the releasing agent, images may not be uniformly formed. Alternatively, a method of forming the surface of a heating roll using a releasing material such as silicon rubber or a fluorine resin and coating the surface with a releasing solution such as silicon oil is generally used. However, a device for coating a releasing solution is required, and the silicon oil may evaporate due to heat resulting in contamination of the device. Furthermore, the electrophotographic imaging apparatus cannot be reduced in size due to the device for coating the releasing solution.

Generally, a styrene-acrylate-based resin or a polyester resin is used as the binder resin which is a major component of toner. The polyester resin has higher anti-hot offset properties and color forming properties but less charge stability against environmental changes compared to the styrene-acrylic resin. Meanwhile, the styrene-acrylate resin has lower hydroscopic properties and better storage stability at high temperatures than the polyester resin. Therefore, attempts have been made to improve properties of binder resins in order to prevent hot offsets.

Japanese Patent Publication No. 2004-295105 discloses a method of manufacturing a toner including dissolving a polyester resin and a styrene-acrylate resin in a solvent and dispersing the solution in water to improve charge stability. However, fixing properties of toner are not improved by using this method.

Japanese Patent Publication No. 2007-093809 discloses a toner prepared by mixing a polyester resin or a styrene-acrylate resin and a hybrid resin or mixing two different hybrid resins. However, hot offsets cannot be prevented in the toner prepared using the hybrid resin and the toner has poor durability.

### DETAILED DESCRIPTION OF THE INVENTION

### Technical Problem

The present invention provides a toner capable of preventing hot offsets and having excellent charge stability against environmental changes and a method of preparing the same.

### Technical Solution

According to an aspect of the present invention, there is provided a toner including: a toner core including a binder resin and a coloring agent; and a toner shell including a crosslinked resin having a tetrahydrofuran (THF)-insoluble content in the range of 99% by weight to 100% by weight and a styrene-acrylate-based resin surrounding the crosslinked resin.

The binder resin may be a polyester resin.

The crosslinked resin may be formed by a reaction between an active hydrogen-containing group of a resin and a crosslinking agent.

The active hydrogen-containing group may include at least one selected from the group consisting of a hydroxyl group, a mercapto group, a carboxyl group, a phosphate group, a sulfonate group, and a sulfate group.

The crosslinking agent may be an isocyanate compound or an epoxy compound.

The crosslinked resin may be formed by a reaction between 1 mol of the active hydrogen-containing group and 0.004 to 0.15 mol of the crosslinking agent.

According to another aspect of the present invention, there is provided a method of preparing a toner, the method including: preparing a toner micro-suspension by adding a mixture including an organic solvent, a binder resin, and a coloring agent to a dispersion medium; preparing a toner composition to form a core by removing the organic solvent from the toner micro-suspension; preparing a micro-suspension by adding a resin having an active hydrogen-containing group and a crosslinking agent to a mixture including a dispersion medium and an organic solvent; preparing a crosslinked resin micro-suspension by removing the organic solvent from the micro-suspension; preparing a polymer suspension to form a shell by adding a mixture including a styrene-based monomer and an acrylate-based monomer to the crosslinked resin micro-suspension and polymerizing the resultant; preparing toner particles by adding the polymer suspension for the shell to the toner composition for the core and aggregating the resultant; and coalescing the aggregated toner particles.

The coloring agent may be a pigment master batch.

The dispersion medium may be a mixture of a polar solvent and a surfactant.

### ADVANTAGEOUS EFFECTS

The present invention provides a toner preventing hot offsets and having excellent charge stability against environmental changes.

### BEST MODE

Hereinafter, the present invention will now be described more fully with reference to exemplary embodiments of the invention.

A toner according to an embodiment of the present invention includes: a toner core including a binder resin and a coloring agent; and a toner shell including a crosslinked resin having a tetrahydrofuran (THF)-insoluble content in the range of 99% by weight to 100% by weight and a styrene-acrylate-based resin surrounding the crosslinked resin.

The toner core may further include at least one additive in addition to the binder resin and the coloring agent.

The binder resin may include a polyester resin which is suitable for dispersion of a coloring agent and fixing at low temperatures. The polyester resin may be prepared by polymerization-condensation of polyhydric alcohol components and polybasic carboxylic acid components while heating, if required, under reduced pressure or in the presence of a catalyst. Examples of the polyhydric alcohol components include polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polybasic carboxylic acid components include an aromatic polybasic acid and/or alkyl esters thereof, which are commonly used in the preparation of polyester resin. Examples of the aromatic polybasic acid include terephthalic acid, isophthalic acid, trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, and/or alkyl esters of these carboxylic acids, wherein the alkyl group may be a methyl group, an ethyl group, a propyl group and/or a butyl group. The aromatic polybasic acid and/or alkyl esters thereof may be used alone or in a combination of at least two thereof.

The amount of the binder resin may be in the range of 50 to 98 parts by weight based on 100 parts by weight of the total amount of the toner composition. If the amount of the binder resin is less than 50 parts by weight, the binder resin is insufficient for binding the toner composition. On the other hand, if the amount of the binder resin is greater than 98 parts by weight, the amount of the toner component except for the binder resin is too small to preserve the function of the toner. In this regard, the total amount of the toner composition includes a coloring agent, additives, and external additives, which will be described later, in addition to the binder resin and the crosslinked resin. The binder resin may have a number average molecular weight in the range of 1,000 to 4,000, a poly dispersity index (PDI) in the range of 2 to 15, and a THF-insoluble content equal to or less than 1% by weight. If the number average molecular weight is less than 1,000, the melt viscosity may be so low that the fixing temperature range may narrow. On the other hand, if the number average molecular weight is greater than 4,000, large particles may be formed while forming particles, resulting in widening of particle size distribution. In addition, if the PDI is less than 2, the fixing temperature range may narrow. On the other hand, if the PDI is greater than 15, it is difficult to prepare a resin having a THF-insoluble content equal to or less than 1% by weight. If the THF-insoluble content is greater than 1% by weight, it is difficult to prepare micro-suspension particles.

The coloring agent contained in the toner core may be a pigment or a pigment master batch in which a pigment is dispersed in a resin. By using this pigment master batch, charging properties of the toner particles may be improved by suppressing the surface exposure of the pigment.

The resin used in the pigment master batch may be the binder resin or any other known resin. The pigment master batch indicates a resin composition in which a pigment is uniformly dispersed. The pigment master batch is prepared by blending a pigment and a resin at high temperature and high pressure or by dissolving a resin in a solvent, adding a pigment to the solution, and applying a high shearing force to disperse the pigment. In the pigment master batch according to an embodiment of the present invention, the amount of the pigment may be in the range of 10 to 70 parts by weight, preferably 20 to 50 parts by weight, based on 100 parts by weight of the pigment master batch. If the amount of the pigment is less than 10 parts by weight based on 100 parts by weight of the pigment master batch, a desired color may not be reproduced because the content of the pigment in the toner is too low. On the other hand, if the amount of the pigment is greater than 70 parts by weight based on 100 parts by weight of the pigment master batch, the pigment may not be uniformly dispersed in the pigment master batch.

The pigment may be selected from pigments that are commonly and commercially used, such as a black pigment, a cyan pigment, a magenta pigment, a yellow pigment, and a mixture thereof.

The coloring agent may be used in an amount sufficient to color the toner and form a visible image when developed, for example, 3 to 15 parts by weight based on 100 parts by weight of the binder resin. If the amount of the coloring agent is less than 3 parts by weight, coloring effects may not be sufficient. On the other hand, if the amount of the coloring agent is greater than 15 parts by weight, a sufficient frictional charge amount may not be obtained due to low electric resistance, thereby causing contamination.

Meanwhile, the additive contained in the toner core includes a charge control agent, a releasing agent, and a mixture thereof.

The charge control agent may be a negative charge control agent or a positive charge control agent. Examples of the negative charge control agent include an organic metal complex or a chelate compound such as an azo complex containing chromium or a mono azo metal complex; a salicylic acid compound containing metal such as chromium, iron, and zinc; and organic metal complexes of an aromatic hydroxycarboxylic acid and an aromatic dicarboxylic acid, and any known negative charge control agent may also be used without limitation. Examples of the positive charge control agent include nigrosine and products of nigrosine modified with a fatty acid metal salt thereof; and an onium salt including a quaternary ammonium salt such as tributylbenzylammonium 1-hydroxy-4-naphthosulfonate and tetrabutylammonium tetrafluoroborate. These positive charge control agents may be used alone or in a combination of two or more thereof. Since the charge control agent stably and quickly charges a toner by its electrostatic force, the toner may be stably supported on a developing roller.

In general, the amount of the charge control agent contained in toner may be in a range of 0.1 to 10 parts by weight based on 100 parts by weight of the toner composition. If the amount of the charge control agent is less than 0.1 parts by weight based on 100 parts by weight of the toner composition, toner charging speed is too low and the charging amount is too low to function as a charge control agent. On the other hand, if the amount of the charge control agent is greater than 10 parts by weight based on 100 parts by weight of the toner composition, overcharging may occur to distort a formed image.

The release agent improves fixing properties of a toner image. Examples of the releasing agent include polyalkylene wax such as low molecular weight polypropylene and low molecular weight polyethylene, ester wax, carnauba wax, and paraffin wax. In general, the amount of the releasing agent contained in toner may be in a range of 0.1 to 30 parts by weight based on 100 parts by weight of the toner composition. If the amount of the releasing agent is less than 0.1 parts by weight, oilless fixing of toner particles cannot be performed. On the other hand, if the amount of the releasing agent is greater than 30 parts by weight, the toner may be flocculated while it is stored.

In addition, the additive may also be a long chain fatty acid, fatty acid amide, metal salts thereof, or the like. The long chain fatty acid, the fatty acid amid, and the metal salts thereof may be used in order to prevent deterioration of developing properties and to obtain high quality images.

The crosslinked resin contained in the toner shell according to an embodiment of the present invention may be formed by a reaction between at least one portion of the active hydrogen-containing group of the resin and the crosslinking agent.

First, the resin including the active hydrogen-containing group will be described.

The active hydrogen-containing group includes at least one selected from the group consisting of a hydroxyl group (OH), a mercapto group (SH), a carboxyl group, a phosphate group, a sulfonate group, and sulfate group, which is easily linked to a crosslinking agent such as an isocyanate compound or an epoxy compound which will be described later. Among them, a resin having a hydroxyl group and/or a carboxyl group is suitable for a reaction with the crosslinking agent. For example, the resin may be a polyester resin having an active hydrogen-containing group. The amount of the active hydrogen-containing group of the resin, which includes the amount of an acid group and the amount of a hydroxyl group of the resin, may be in the range of 0.1 to 2 mmol KOH/g. If the amount of the active hydrogen-containing group is less than 0.1 mmol KOH/g, a toner which will be described later may not be easily prepared and charge properties may deteriorate. On the other hand, if the amount of the active hydrogen-containing group is greater than 2 mmol KOH/g, environmental stability of the prepared toner may be significantly decreased. The amount of the active hydrogen-containing group may be in the range of 0.15 to 1.2 mmol KOH/g.

The number average molecular weight of the resin having the active hydrogen-containing group may be in the range of 600 to 4,000. If the number average molecular weight of the resin is less than 600, the melt viscosity may be so low that the fixing temperature range may narrow. On the other hand, if the number average molecular weight of the resin is greater than 4,000, reactivity with the crosslinking agent may decrease and fixing properties at low temperatures and glossiness may deteriorate since the amount of polymers having higher molecular weight increases even though a crosslinking reaction occurs.

The crosslinking agent involved in a reaction with the resin including the active hydrogen-containing group may be an isocyanate compound or an epoxy compound, preferably an isocyanate compound.

The isocyanate compound may be any known aromatic, aliphatic, and/or alicyclic isocyanate compound, a trifunctional isocyanate compound, a polyol, and isocyanate functional adducts of a polyol and a diisocyanate compound. Examples of the isocyanate compound include 1,6-hexamethylene diisocyanate, isophorone diisocyanate, 4,4-biphenylene diisocyanate, toluene diisocyanate, bis-cyclohexyl diisocyanate, tetramethylene xylene diisocyanate, ethyl ethylene diisocyanate, 2,3-dimethyl ethylene diisocyanate, 1-methyltrimethylene diisocyanate, 1,3-phenylene diisocyanate, 1,5-naphthalene diisocyanate, bis-(4-isocyanatocyclohexyl)-methane, 4,4-diisocyanatodiphenyl ether, triphenylmethane triisocyanate, 1,3,5-benzene triisocyanate, 2,4,6-toluene triisocyanate, a trifunctional adducts of triol and diisocyanate, and/or polyisocyanate blocked with a phenol derivative, oxime, caprolactam, dimethylpyrazole, or the like. At least two of these polyisocyanates may be used in combination. If a block copolymerized isocyanate is used, it may be pressurized to a temperature at which the blocked group is dissociate in order to dissociate the blocked group.

The epoxy compound may be a compound having 2 to 5 epoxy functional groups such as a diphenylolpropane type epoxy resin, a diphenylolmethane type epoxy resin, a Novolac type epoxy resin, a diamine type epoxy resin, a diacid type epoxy resin, and a diol type epoxy resin.

In general, the amount of the crosslinking agent may be in the range of 0.004 to 0.15 mol, preferably, 0.008 to 0.075 mol, based on 1 mol of the active hydrogen-containing group of the resin.

If the amount of the crosslinking agent is less than 0.004 mol, crosslinking is not sufficiently performed. Thus, storage stability at high temperature and anti-hot offset properties may deteriorate, thereby narrowing a fixing temperature range. On the other hand, if the amount of the crosslinking agent is greater than 0.15 mol, the content of high molecular weight components increases by crosslinking, and thus fixing properties at low temperature may deteriorate.

The crosslinked resin is formed by a crosslinking reaction between the active hydrogen-containing group of the resin and the crosslinking agent.

The styrene-acrylate-based resin surrounding the crosslinked resin contained in the toner shell according to an embodiment of the present invention is a hydrophobic resin and may be polymerized using a mixture of a styrene-acrylate-based ethylenically unsaturated monomer in the presence of an emulsifier and a polymerization initiator. The ethylenically unsaturated monomer may include at least one selected from the group consisting of: an aromatic vinyl monomer such as styrene, a-methylstyrene, ethylstyrene, vinyl toluene, p-methylstyrene, chlorostyrene, or vinyl naphthalene; an unsaturated carboxylic acid alkyl ester such as methyl acrylate, methyl methacrylate, ethyl acrylate, ethyl methacrylate, butyl acrylate, or butyl methacrylate; an unsaturated carboxylic acid hydroxyalkyl ester such as β-hydroxyethyl acrylate, β-hydroxypropyl acrylate, or β-hydroxyethyl methacrylate; an unsaturated carboxylic acid amide such as dimethylaminoethyl methacrylate, diethylaminoethyl methacrylate, dimethylaminopropyl methacrylate, acryl amide, methacryl amide, itaconic acid amide, maleic acid mono amide, N-methylol methacryl amide, or derivatives thereof; vinyl acetate; and vinyl pyridine.

The styrene-acrylate-based resin may further include a crosslinkable monomer having at least two vinyl groups. The crosslinkable monomer may include at least one selected from the group consisting of aryl acrylate, acryl methacrylate, ethylene glycol dimethacrylate, ethylene glycol diacrylate, 1,6-hexanediol dimethacrylate, 1,6-hexanediol diacrylate, diaryl phthalate, divinyl benzene, trimethylol propane triacrylate, trimethylol propane trimethacrylate, diaryl malate, trans-farnersyl acetate, and pentaerythritol tetraacrylate.

The amount of the styrene-acrylate-based resin surrounding the crosslinked resin contained in the toner shell according to an embodiment of the present invention is in the range of 10 to 50 parts by weight based on 100 parts by weight of the total amount of the crosslinked resin and the styrene-acrylate-based resin. If the amount of the styrene-acrylate-based resin is less than 10 parts by weight, the fixing temperature range may become narrow. On the other hand, if the amount of the styrene-acrylate-based resin is greater than 50 parts by weight, the resin becomes stiff so that fixing properties at low temperatures deteriorate and compatibility with the binder resin decreases so that toner particles may not be aggregated.

The toner according to an embodiment of the present invention has a complex structure in which a shell including the styrene-acrylate-based resin surrounding the crosslinked resin surrounds a core including the binder resin and the coloring agent.

The toner may further include external additives. The external additives are used to improve fluidity of the toner or control charge properties of the toner. Examples of the external additives are large particulate silica, small particulate silica, and polymer beads.

A method of preparing a toner according to another embodiment of the present invention includes: preparing a toner micro-suspension by adding a mixture including an organic solvent, a binder resin, and a coloring agent to a dispersion medium; preparing a toner composition to form a core by removing the organic solvent from the toner micro-suspension; preparing a micro-suspension by adding a resin having an active hydrogen-containing group and a crosslinking agent to a mixture including a dispersion medium and an organic solvent; preparing a crosslinked resin micro-suspension by removing the organic solvent from the micro-suspension; preparing a polymer suspension to form a shell by adding a mixture including a styrene-based monomer and an acrylate-based monomer to the crosslinked resin micro-suspension and polymerizing the resultant; preparing toner particles by adding the polymer suspension to form the shell to the toner composition to form the core and aggregating the resultant; and coalescing the aggregated toner particles. Hereinafter, the method of preparing a toner will be described.

First, a mixture including an organic solvent, a binder resin, a coloring agent, and at least one additive, if required, is added to a dispersion medium to prepare a toner mixture. Then, the toner mixture was added to a dispersion medium including a polar solvent, a surfactant, and selectively a thickener and the resultant is stirred to prepare a toner micro-suspension.

Then, the organic solvent is removed while the toner micro-suspension is stirred and heated, preferably under a reduced pressure, to prepare a toner composition to form the core.

Meanwhile, a dispersion medium is prepared by mixing a polar solvent, a surfactant, and selectively a thickener, and then stirring and heating the mixture to sufficiently dissolve solids contained in the mixture. If the solids are completely dissolved, an organic solvent is added to the dispersion medium to prepare a milky-white liquid composition. Then, a resin having an active hydrogen-containing group and a crosslinking agent are added to the liquid composition, and the resultant is mixed to prepare a micro-suspension.

Then, the organic solvent is removed while the micro-suspension is stirred and heated, preferably under a reduced pressure, to prepare a crosslinked resin micro-suspension.

An emulsion monomer mixture prepared by mixing a polar solvent, a surfactant, a styrene-based monomer, and an acrylate-based monomer is gradually added to the crosslinked resin micro-suspension in the presence of an initiator to prepare a polymer suspension to form the shell including the styrene-acrylate-based resin surrounding the crosslinked resin.

Then, the polymer suspension to form the shell is added to the toner composition to form the core, and the resultant is mixed and aggregated by using an aggregating agent and controlling temperature and pH to prepare toner particles.

Then, the toner particles are coalesced to prepare a toner complex having a desired particle size. By such coalescence, the rigidity of the toner particles increases, and the shape of the toner particles becomes regular. In addition, the shapes of the toner particles may change from contorted spheres to complete spherical shapes according to the degree of the coalescence. In particular, by such coalescence, a toner having a core-shell structure in which the polymer to form the shell including the styrene-acrylate-based resin surrounding the crosslinked resin surrounds toner particles to form the core is prepared. That is, although the binder resin is combined by the coalescence, the styrene-acrylate-based resin surrounding the crosslinked resin is not coalesced with the binder resin and surrounds the external surface of the toner particles as a shell.

Finally, the coalesced toner is cooled, washed, and dried to obtain toner particles.

The organic solvent used herein is volatile, has a lower boiling point than a polar solvent, and is not miscible with the polar solvent. The organic solvent may include at least one selected from the group consisting of esters such as methyl acetate or ethyl acetate; ketones such as acetone or methylethyl ketone; hydrocarbons such as dichloromethane or trichloroethane; and aromatic hydrocarbons such as benzene.

The polar solvent may include at least one selected from the group consisting of water, glycerol, ethanol, ethylene glycol, propylene glycol, diethylene glycol and dipropylene glycol, sorbitol, and preferably water.

The thickener may include at least one selected from the group consisting of polyvinyl pyrrolidone, polyvinyl alcohol, polyacrylic acid, gelatin, chitosan and sodium alginate, and preferably polyvinyl alcohol.

The surfactant may include at least one selected from the group consisting of a nonionic surfactant, an anionic surfactant, a cationic surfactant, and an amphoteric surfactant.

The aggregating agent used in the method of preparing the toner according to the current embodiment may be a surfactant used in the dispersion medium, a surfactant having an opposite polarity to the surfactant used in the dispersion medium or a monovalent or higher inorganic metal salt.

The toner prepared by the method according to an embodiment of the present invention may be applied to an electrophotographic image forming device. In this regard, the electrophotographic image forming apparatus includes laser printers, photocopiers, or facsimiles.

The present invention will be described in more detail with reference to the examples below, but is not limited thereto. The following examples are for illustrative purposes only and are not intended to limit the scope of the invention.

### PREPARATION EXAMPLES

Synthesis of polyester resin having active hydrogen-containing group

### Preparation Example 1: Synthesis of Polyester Resin 1

A 3 L reactor equipped with a stirrer, a thermometer, and a condenser was installed in an oil bath including a heating medium. 50 g of dimethyl terephthalate, 47 g of dimethyl isophthalate, 80 g of 1,2-propylene glycol, and 3 g of trimellitic acid were added to the reactor. Then, 0.09 g of dibutyl tin oxide was added thereto as a catalyst at a ratio of 500 ppm with respect to the total weight of the monomers. Then, the reactor was heated to 150° C. while stirring the mixture of the reactor at a speed of 150 rpm. The reaction was maintained at the same temperature for about 6 hours, and the reactor was heated to 220° C. The pressure of the reactor was reduced to 0.1 torr in order to remove byproducts, and the reactor was maintained at the same pressure for 15 hours to complete the reaction. As a result, polyester resin 1 was obtained.

The glass transition temperature (Tg) of the polyester resin 1 measured using a differential scanning calorimeter (DSC) was 62° C. The number average molecular weight and poly dispersity index (PDI) of the polyester resin 1 were measured by gel permeation chromatography (GPC) using polystyrene as a standard sample and they were respectively 4,000 and 3.5. The amount of the active hydrogen-containing group measured by titration was 0.4 mmolKOH/g.

### Preparation Example 2: Synthesis of Polyester Resin 2

Polyester resin 2 was prepared in the same manner as in Preparation Example 1, except that the process of removing byproducts was performed for 10 hours. As a result of measuring Tg of the polyester resin 2 using a DSC after the reaction, the Tg was 58° C. The number average molecular weight and PDI of the polyester resin 2 measured by a GPC using polystyrene as a standard sample were respectively 2,100 and 3.4. The amount of the active hydrogen-containing group measured by titration was 0.2 mmolKOH/g.

### PREPARATION OF PIGMENT MASTER BATCH

### Preparation Example 3: Preparation of Black Pigment Master Batch

The polyester resin 1 synthesized in Preparation Example 1 and a carbon black pigment (Degussa GmbH, Germany, NIPEX 150) were mixed at a weight ratio of 8:2. Then, 50 parts by weight of ethyl acetate based on 100 parts by weight of the polyester resin 1 was added thereto, and the mixture was heated to about 60° C., and then stirred with a kneader for 60 minutes.

Then, while the mixture was mixed at a rate of 50 rpm using a biaxial extruder having a vacuum device, ethyl acetate as a solvent was removed using the vacuum device to obtain a black pigment master batch.

### PREPARATION OF CROSSLINKED RESIN

### Preparation Example 4

400 g of distilled water, 20 g of polyvinyl alcohol (P-24, manufactured by DC Chemical Co., Seoul, Korea), 14 g of a neutral surfactant (tween 20TM, Aldrich Chemical Company, Milwaukee, Wis.), and 4 g of sodium dodecyl sulfate (manufactured by Aldrich Chemical Company) as an anionic surfactant were added to a 1 L reactor equipped with a condenser, a thermometer, and a impeller stirrer, and then solids were completely dissolved by heating and stirring the reactor at a rate of 500 rpm at 70° C. After the solids are completely dissolved, 100 g of methyl ethyl ketone (manufactured by Aldrich Chemical Company) was added to the reactor to obtain a milky-white liquid composition. 120 g of polyester resin 2 synthesized according to Preparation Example 2 and 6 g of an isocyanate crosslinking agent (toluene diisocyanate, Aldrich Chemical Company, 0.07 mol based on 1 mol of the active hydrogen-containing group of the resin) were added to the liquid composition, and then the mixture was refluxed while stirring at 1000 rpm at 75° C. for 5 hours to prepare a micro-suspension. Then, the stirring speed was decreased to 300 rpm, and methyl ethyl ketone as an organic solvent was removed from the reactor under a partially reduced pressure of 100 mmHg while the reactor was maintained at 90° C. and collected using a condenser. After 4 hours, the amount of obtained methyl ethyl ketone was measured to identify that the methyl ethyl ketone had been completely removed. Then, the reactor was cooled to 25° C. to obtain a crosslinked resin micro-suspension. A volume average particle size of micro-particles of the crosslinked resin was 280 nm, and a THF-insoluble content of the crosslinked resin was 99% by weight.

### PREPARATION OF POLYMER SUSPENSION TO FORM SHELL

### Preparation Example 5

70 g of distilled water was added to the crosslinked resin micro-suspension prepared according to Preparation Example 4, and the mixture was heated to 75° C. while stirring. 70 g of distilled water, 1 g of sodium dodecyl sulfate, 40 g of a styrene monomer, and 10 g of a butyl acrylate monomer were mixed to prepare a monomer emulsion. Then, 10 g of 5% potassium persulfate was added to the crosslinked resin micro-suspension heated to 75° C., and the monomer emulsion was gradually added thereto for 300 minutes to perform polymerization. After the monomer emulsion was added, the reactor was further maintained at 75° C. for 180 minutes. Then, the reactor was cooled to 25° C. to obtain a polymer suspension to form a shell including a styrene-acrylate-based resin surrounding a crosslinked resin. A volume average particle size of the polymer suspension to form the shell was 310 nm.

### Preparation Example 6

A polymer suspension to form a shell was prepared in the same manner as in Preparation Example 5, except that the monomer emulsion was prepared by mixing 150 g of distilled water, 2 g of sodium dodecyl sulfate, 80 g of a styrene monomer, and 20 g of a butyl acrylate monomer, and 20 g of 5% potassium persulfate was used.

### PREPARATION OF TONER PARTICLES

### Example 1

60 g of polyester resin 1 synthesized according to Preparation Example 1, 40 g of a black pigment master batch synthesized according to Preparation Example 3, 1 g of a charge control agent (N-23; HB Dinglong Co.), 4 g of paraffin wax, and 150 g of methyl ethyl ketone as an organic solvent were added to a 1 L reactor equipped with a condenser, a thermometer, and an impeller stirrer to prepare a toner mixture. While the toner mixture was stirred at a rate of 600 rpm, 25 ml of 1N NaOH solution was added thereto. Then, the toner mixture was mixed at 80° C. for 5 hours while refluxing. When the toner mixture has sufficient fluidity, it was further stirred at 500 rpm for 2 hours.

Then, 600 g of distilled water, 5 g of a neutral surfactant (Tween 20, Aldrich Co.), and 1 g of sodium dodecyl sulfate (Aldrich Co.) as an anionic surfactant were added to a separate 3 L reactor equipped with a condenser, a thermometer and an impeller stirrer. Then, the mixture was stirred at 85° C. at 600 rpm for 1 hour to obtain a dispersion medium.

The toner mixture was added to the dispersion medium and the mixture was stirred at the same temperature, i.e., 85° C., at 1000 rpm for 1 hour to prepare a toner micro-suspension.

Then, methyl ethyl ketone as an organic solvent was removed at a partially reduced pressure of 100 mmHg while the reactor was maintained at 90° C. to obtain a toner composition to form a core. The size of the toner composition in which methyl ethyl ketone was removed was measured using a Coulter Multisizer (Beckman Coulter Co.), and the volume average particle size was 400 nm.

Then, the polymer suspension to form the shell prepared according to Preparation Example 5 was added to the reactor including the toner composition.

Subsequently, 10 g of magnesium chloride dissolved in 50 g of distilled water was gradually added to the reactor, and the reactor was heated to 80° C. for 30 minutes to obtain toner particles by aggregating the mixture including the polymer to form the shell and the toner composition. After 5 hours, as a result of measuring the size of the aggregated toner particles by using a Coulter Multisizer (Beckman Coulter Co.), the volume average particle size was 6.8 μm.

Then, coalescence was performed at 80° C. for 8 hours by adding 500 g of distilled water to the reactor, and the reactor was cooled.

Then, the coalesced toner particles were separated using a filter that is commonly used in the art, washed with 1 N hydrochloric acid solution, and washed again 5 times with distilled water to completely remove the surfactant, and the like. The washed toner particles were dried in a fluidized bed dryer at 40° C. for 5 hours to obtain dried toner particles.

As a result of analyzing the obtained toner particles, it was determined that the toner particles had a volume average particle size of 6.9 μm and an 80% span value of 0.65. In addition, as a result of analyzing 100 random toner particle samples by using Image J software using a scanning electron microscope (SEM; JEOL Ltd.), it was determined that a mean shape factor was 0.90.

### Example 2

Toner particles were prepared in the same manner as in Example 1, except that the crosslinked resin prepared according to Preparation Example 6 was used.

As a result of analyzing the obtained toner particles, it was determined that the toner particles had a volume average particle size of 7.0 μm and an 80% span value of 0.63. In addition, as a result of analyzing 100 random toner particle samples by using Image J software using a scanning electron microscope (SEM; JEOL Ltd.), it was determined that a mean shape factor was 0.91.

### Comparative Example 1

Toner particles were prepared in the same manner in Example 1, except that the process of mixing the obtained toner composition with the polymer suspension to form the shell prepared according to Preparation Example 5 was not performed.

As a result of analyzing the obtained toner particles, it was determined that the toner particles had a volume average particle size of 6.5 μm and an 80% span value of 0.65. In addition, as a result of analyzing 100 random toner particle samples by using Image J software using a scanning electron microscope (SEM; JEOL Ltd.), it was determined that a mean shape factor was 0.87.

Volume average particle sizes of the toner according to Examples 1 to 2 and Comparative Example 1 were measured using a Coulter Multisizer 3. An aperture of 100 μm was used in the Coulter Multisizer 3, an appropriate amount of a surfactant was added to 50 to 100 ml of ISOTON-II (Beckman Coulter Co.), as an electrolyte, and 10 to 15 mg of a sample to be measured was added thereto. Then, the resultant was dispersed in an ultrasonic dispersing apparatus for 5 minutes to prepare a sample for the Coulter Multisizer 3.

In addition, the 80% span value, indicating the particle size distribution, was calculated using Equation 1 below. The volume of toner particles is accumulated from particles of the smallest size in ascending order until the accumulated volume reaches 10% of the total volume of the toner. An average particle size of the accumulated particles corresponding to 10% of the total volume of the toner is defined as d10. Average particle sizes of the accumulated particles corresponding to 50% and 90% of the total volume of the toner are respectively defined as d50 and d90.

### <Equation 1>

80% span value=(d90−d10)/d50

In this regard, a smaller span value indicates a narrower particle size distribution, and a larger span value indicates a wider particle size distribution.

In addition, the shape factor was calculated using Equation 2 below by measuring SEM images (×1,500) of 100 random toner particles and analyzing them using Image J software.

### <Equation 2>

Shape factor=4π(area/(perimeter)²)

In this regard, the area indicates a projected area of the toner and the perimeter indicates a projected circumference of the toner. The shape factor may be in the range of 0 to 1, wherein the closer the shape factor is to 1, the more circular the toner is.

Meanwhile, a method of evaluating resins is as follows.

A glass transition temperature (Tg) of a sample is measured using a differential scanning calorimeter (DSC, manufactured by Netzsch Co.) by heating the sample from 20 to 200° C. at 10° C./min, rapidly cooling it to 10° C. at 20° C./min, and heating it at 10° C./min.

The amount of the active hydrogen-containing group includes the amount of an acid group and the amount of a hydroxyl group and may be obtained as follows.

First, the amount (mmol KOH/g) of the acid group is obtained by: titrating a solution prepared by dissolving 0.5 to 2 g of the resin in 100 ml of dichloromethane and cooled using a 0.1 N KOH methyl alcohol solution by a titration device using an electric potential difference (Metrohm 736 GP Titrino, Metrohm); and measuring the amount S (ml) of the 0.1 N KOH methyl alcohol solution used in the titration and the weight W (g) of the resin using Equation 3 below.

### <Equation 3>

Amount of the acid group (mmol KOH/g)=S/(W×10)

Then, the amount (mmol KOH/g) of the hydroxyl group is obtained as follows. 0.5 to 2 g of the resin was mixed with 1 to 2 g of acetic anhydride and 3 to 4 g of pyridine and the mixture was maintained at 90 to 100° C. for 1 hour and cooled. 1 to 2 ml of water was added to the mixture to decompose unreacted acetic anhydride. 100 ml of dichloromethane was added thereto to dissolve the mixture. Then, the mixture was titrated using the 0.1 N KOH methyl alcohol solution in the same manner as the measuring of the amount of the acid group to measure the amount S′ (ml) of the 0.1 N KOH methyl alcohol solution used in the titration and the weight W′ (g) of the resin. A blank experiment was performed using the mixture except for the resin to measure the amount B (ml) of 0.1 N KOH used in the titration, and the amount of the hydroxyl group was measured using Equation 4 below.

### <Equation 4>

Amount of the hydroxyl group (mmol KOH/g)=(B−S′)/(W′×10)+the amount of the acid group

Toner particles prepared according to Examples 1 to 2 and Comparative Example 1 were evaluated as follows.

Fixing temperature range: Resistance to hot offset

100 g of toner particles, 2 g of silica (TG 810G, Cabot Co.), and 0.5 g of silica (RX50, Degussa GmbH) were mixed to prepare a toner composition. Using the toner composition, unfixed images in a 30 mm×40 mm solid state were collected from a Samsung CLP-510 printer. Then, the fixing properties of the unfixed images were evaluated while varying the temperature of a fixing roller at a fixing tester in which the fixing temperature could be controlled.

Charge stability against environmental changes

0.2 g of each of the toner placed under three different environmental conditions (temperature/humidity) as follows for 16 hours and 2 g of a carrier were mixed at 150 rpm for 15 minutes. Then, a blow off charge amount (Vertex Co.) was measured by using a common method of measuring charge amount of two-component toner.

1) 10° C./10% 2) 25° C./55% 3) 32° C./80%

The results of the evaluation are shown in Table 1 below.

TABLE 1

| | Fixing | | | |
|---|---|---|---|---|
| | temperature | Charge stability (μC/g) | | |
| | range (° C.) | 10° C./10% | 25° C./55% | 32° C./80% |
| Example 1 | 130~210 | −22.8 | −23.2 | −21.5 |
| Example 2 | 130~220 | −23.8 | −24.2 | −23.5 |
| Comparative | 120~170 | −24.2 | −21.8 | −17.3 |
| Example 1 | | | | |

Referring to Table 1, the fixing temperature range of the toner prepared in Example 1 was in the range of 130 to 210° C., the fixing temperature range of the toner prepared in Example 2 was in the range of 130 to 220° C., and the fixing temperature range of the toner prepared in Comparative Example 1 was in the range of 120 to 170° C. Thus, the fixing temperature ranges of the toner prepared in Examples 1 and 2, particularly at high temperature, are wider than that prepared according to Comparative Example 1. Accordingly, hot offset may less occur in the toner of Examples 1 and 2 compared to the toner of Comparative Example 1. Furthermore, with regard to charge stability against environmental changes, while the variation of the charge amount of the toner of Comparative Example 1 is high as the temperature and humidity increase, the variation of the charge amount of the toner of Examples 1 and 2 is low. Thus, it can be seen that charge stability against environmental changes of the toner prepared in Examples 1 to 2 is better than that of Comparative Example 1.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A toner comprising:
a toner core comprising a binder resin and a coloring agent; and
a toner shell comprising a crosslinked resin having a tetrahydrofuran (THF)-insoluble content in the range of 99% by weight to 100% by weight and a styrene-acrylate-based resin surrounding the crosslinked resin.

2. The toner of claim 1, wherein the crosslinked resin is formed by a reaction between an active hydrogen-containing group of a resin and a crosslinking agent.

3. The toner of claim 1, wherein the amount of the styrene-acrylate-based resin is in the range of 10 to 50 parts by weight based on 100 parts by weight of the total amount of the crosslinked resin and the styrene-acrylate-based resin.

4. The toner of claim 2, wherein the active hydrogen-containing group comprises at least one selected from the group consisting of a hydroxyl group, a mercapto group, a carboxyl group, a phosphate group, a sulfonate group, and a sulfate group.

5. The toner of claim 2, wherein the crosslinking agent is an isocyanate compound or an epoxy compound.

6. The toner of claim 2, wherein the crosslinked resin is formed by a reaction between the active hydrogen-containing group and the crosslinking agent at a ratio of 1 mol to 0.004 to 0.15 mol.

7. A method of preparing a toner, the method comprising:
preparing a toner micro-suspension by adding a mixture comprising an organic solvent, a binder resin, and a coloring agent to a dispersion medium;
preparing a toner composition to form a core by removing the organic solvent from the toner micro-suspension;
preparing a micro-suspension by adding a resin having an active hydrogen-containing group and a crosslinking agent to a mixture comprising a dispersion medium and an organic solvent;
preparing a crosslinked resin micro-suspension by removing the organic solvent from the micro-suspension;
preparing a polymer suspension to form a shell by adding a mixture comprising a styrene-based monomer and an acrylate-based monomer to the crosslinked resin micro-suspension and polymerizing the resultant;
preparing toner particles by adding the polymer suspension to form the shell to the toner composition to form the core and aggregating the resultant; and
coalescing the aggregated toner particles.

8. The method of claim 7, wherein the active hydrogen-containing group comprises at least one selected from the group consisting of a hydroxyl group, a mercapto group, a carboxyl group, a phosphate group, a sulfonate group, and a sulfate group.

9. The method of claim 7, wherein the crosslinking agent is an isocyanate compound or an epoxy compound.

10. The method of claim 7, wherein the amount of the crosslinking agent is in the range of 0.004 to 0.15 mol based on 1 mol of the active hydrogen-containing group.

11. The method of claim 7, wherein the coloring agent is a pigment master batch.

12. The method of claim 7, wherein the dispersion medium is a mixture of a polar solvent and a surfactant.
